(19) United States
(12) Patent Application Publication
(10) Pub. No.: US 2013/0042186 A1
(43) Pub. Date: Feb. 14, 2013

(54) Real-time web-based debate platform

(71) Applicant: Daniel M. Tranchina, Sonoma, CA (US)

(72) Inventor: Daniel M. Tranchina, Sonoma, CA (US)

(73) Assignee: SPEAKYOURTONGUE, INC, Sonoma, CA (US)

(21) Appl. No.: 13/572,644

(22) Filed: Aug. 11, 2012

Related U.S. Application Data
(60) Provisional application No. 61/522,387, filed on Aug. 11, 2011.

(51) Int. Cl. G06F 3/01

(52) U.S. Cl. 715/753

(57) ABSTRACT

Real-Time computer-implemented processes, computer-program instructions, hardware and services and features redefining the value of social interaction and free speech debate on the Internet by placing value on every user's voice in a powerful and easy to use social media platform that interacts in real-time with the issues facing our world and of importance to the users themselves.

### CROSS REFERENCE TO RELATED APPLICATIONS

This application claims the benefit of U.S. Provisional Application No. 61/522,387, filed 11 Aug. 2012, the contents of which are hereby expressly incorporated in its entirety by reference thereto for all purposes.

### COPYRIGHT OF INVENTION

A portion of the disclosure of this patent document contains material to which a claim of copyright protection is made. The copyright owner has no objection to the facsimile or reproduction by anyone of the patent document or the patent disclosure, as it appears in the Patent and Trademark Office patent file or records, but reserves all other rights whatsoever.

### BACKGROUND OF THE INVENTION

The present invention relates generally to a method, process, and computer program product for a real-time web-based synchronized debate platform, and more specifically, but not exclusively, to generalized synchronized exchanges of individual points-of-view for a user-identified topic.

Web based social networking and social media sites make it possible to connect people together who share interests and activities, leading to increased levels of information sharing. While fairly new, by some measures, social networking and media represents a big market. Social networking and media continue to expand rapidly by providing new features and services for users. Therefore there is an opportunity for accessing this market through the implementation of new features and technology.

There are many thousands of websites containing vast amounts of content. There are at least three common scenarios for these websites: an “information” site where an information reporter/aggregator offers a news item, a BLOG site where a poster offers some content, typically opinion content, and a social media site where users gather online to share/exchange content or status information. Virtually all of these sites offer their readers an opportunity to comment about the news, opinion, or content. Sometimes the comments, collectively, become a limited form of discussion as commentators begin commenting about or otherwise responding to other commentators' comments in addition to, or in lieu of, commenting about the original news item, opinion, or content.

This form of discussion is limited for several reasons and does not rise to the level of an engaged, interactive debate as that term is used herein. Some of the reasons relate to the comments being asynchronous, often stale, and typically presented as static rendered content on a webpage. It is not uncommon for the comments to be displayed in static format distributed over multiple pages, and it is often the case that the newest comments are at the latter pages. It is not uncommon for a user has to refresh and then navigate to the desired location and it may be that the newest comments are not yet available, as the comments are often reviewed by a moderator (e.g., an automated process or a “live” person).

This commenting feature of these sites is typically labeled simply: “comments”—and was designed for users to share their thoughts about the news, opinion, or content. That users have attempted to repurpose the original design for discussions with other commentators shows that there is a desire among users to engage with others, particularly regarding topics of interest to them. Sometimes one or more users try to change the “discussion” to be a variation of the topic presented, or several users try to have multiple discussions on different variations. It can be become difficult and hard to follow, even for those users interested in expending the effort. The options for those users desiring to interact and engage with others, particularly for their “variation” of the original topic, is minimal at best. It can be hard to track and follow and provide comments on any particular variation. While some designs have enabled the comments section to have conversation thread features to help group related comments, these conversation threads are not really adequate for the task of improving engaged, interactive discussion. This is particularly true when there are multiple people with multiple variations interposed asynchronously all making comments, responses, arguments, and the like.

There have been various text-based systems for real-time discussion in very specific ways. They are typically a variation of Internet Relay Chat (IRC) that provides limited tools for implementing multiuser discussions. These are often standalone implementations and are not integrated into social media and networking sites.

There are many reasons why websites and portals are designed and implemented in this way, but these reasons do not include a desire to provide a real-time synchronous debate platform for two or more users to engage and debate about topics of their choosing. What is needed is a method, process, and computer program product for real-time web-based debate platform allowing generalized synchronized exchanges of individual points-of-view on a user-identified topic.

### BRIEF SUMMARY OF THE INVENTION

Disclosed is a system, method, and computer program product including a method, process, and computer program product for real-time web-based debate platform allowing generalized synchronized exchanges of individual points-of-view on a user-identified topic. The following summary of the invention is provided to facilitate an understanding of some of technical features related to real-time debate platforms, particularly to web-based systems, and is not intended to be a full description of the present invention. A full appreciation of the various aspects of the invention can be gained by taking the entire specification, claims, drawings, and abstract as a whole.

At the forefront of the social networking and media revolution expansion is the new concept of “real-time.” Real time allows users to contribute content, which is then instantly broadcast. Preferred embodiments of the present invention is that of a real-time, interactive debate, streaming information hub that offers a snapshot of any given topic, subject or issue. In addition, it allows and enables the end user to instantly create their own debate or discussion on any given topic, subject or issue in Real-time. As well as connect, share, analyze debate, discuss, and dissect global news stories. This allows the user to seamlessly and instantaneously engage with one another in the national and global dialogue unlike any other social media platform available today.

The time for “political correctness” is over! The current international dialogue is ready for a new real-time, interactive, streaming information hub allowing the user to seamlessly engage in the international, national and local dialogue unlike any other social media platform available today. Our intention is to take advantage of the current political and social climate to launch our real-time online communication solution.

SpeakYourTongue.com will be the destination for people to use SYT's personalized Internet environment to explore, share, connect and debate on politics, business, entertainment, sports, and religious issues—all in one easy to use platform. A place that bridges the social gap between GenXer's and GenNexters. A place on the web to congregate and exchange ideas, where open dialogue is truly embraced while facilitating an environment that is cool, hip, inspiring and positive.

This is just what the people of this Country need and want. According to a recent survey by Gallup, 57% of Americans have significantly lost trust in Government Agencies, Politicians and Main Media Channels. This cynicism provides an opportunity for a new kind of platform—This is SpeakYourTongue.com.

According to Forrester Research, Internet Social Media will continue to grow 28% a year over the next five years. Based on our extensive research, we have identified a need in the marketplace. What people truly desire is a bold and innovative social media platform for their voices to be heard loud and clear!

There are many possible implementation of the present invention which may integrates different sources of user interest including: business, politics, media, sports, entertainment, technology, religion and health categories with the ability to view and debate on, up to the minute real-time issues.

Other features, benefits, and advantages of the present invention will be apparent upon a review of the present disclosure, including the specification, drawings, and claims.

### BRIEF DESCRIPTION OF THE DRAWINGS

The accompanying figures, in which like reference numerals refer to identical or functionally-similar elements throughout the separate views and which are incorporated in and form a part of the specification, further illustrate the present invention and, together with the detailed description of the invention, serve to explain the principles of the present invention.

FIG. 1 illustrates a block component diagram for a web-available debate platform;

FIG. 2 illustrates a block diagram of functional elements of the server included in the debate platform shown in FIG. 1;

FIG. 3 illustrates a block diagram of functional elements of the client included in the debate platform shown in FIG. 1;

FIG. 4 illustrates a block diagram of the hardware elements of the server included in the debate platform shown in FIG. 1;

FIG. 5 illustrates a block diagram of hardware elements of the client included in the debate platform shown in FIG. 1;

FIG. 6 illustrates a representative architecture for a preferred implementation;

FIG. 7 through FIG. 10 illustrates a functional description of architecture features shown in FIG. 6;

FIG. 11 illustrates global connectivity for debate platform 100 shown in FIG. 1;

FIG. 12 illustrates representative global TV and Media integration for debate platform 100 shown in FIG. 1;

FIG. 13 illustrates representative educational institution integration for debate platform 100 shown in FIG. 1;

FIG. 14 illustrates representative I/O interface implementation for debate platform 100;

FIG. 15 illustrates representative I/O interface implementation for debate platform 100;

FIG. 16 illustrates a live, real-time posting and moderator(s) feature diagram;

FIG. 17 illustrates a representative main page for a preferred implementation including server and user created topics and a topic history of debate platform 100 shown in FIG. 1;

FIG. 18 illustrates a representative child page for one of the debate categories of debate platform 100 shown in FIG. 1;

FIG. 19 illustrates a representative child page for user debate topic creation using platform 100 shown in FIG. 1;

FIG. 20 illustrates additional details of representative main page shown in FIG. 17;

FIG. 21 illustrates additional details of representative child page shown in FIG. 18;

FIG. 22 illustrates additional details of representative topic creation page shown in FIG. 19;

FIG. 23 illustrates real-time connectivity and integration for debate platform 100 shown in FIG. 1;

FIG. 24 illustrates additional interface details for debate platform 100 shown in FIG. 1;

FIG. 25 illustrates additional educational integration details for debate platform 100 shown in FIG. 1; and

FIG. 26 illustrates features of a preferred implementation of debate platform 100 shown in FIG. 1.

### DETAILED DESCRIPTION OF THE INVENTION

Embodiments of the present invention provide a method, process, and computer program product for real-time web-based debate platform allowing generalized synchronized exchanges of individual points-of-view on a user-identified topic. The following description is presented to enable one of ordinary skill in the art to make and use the invention and is provided in the context of a patent application and its requirements.

Various modifications to the preferred embodiment and the generic principles and features described herein will be readily apparent to those skilled in the art. Thus, the present invention is not intended to be limited to the embodiment shown but is to be accorded the widest scope consistent with the principles and features described herein.

As noted herein, the system and process are most preferably implemented in a system and method, including computer-implemented methods having a processor executing computer program instructions from a memory to effect the real-time debate between multiple users of topics of interest to them personally.

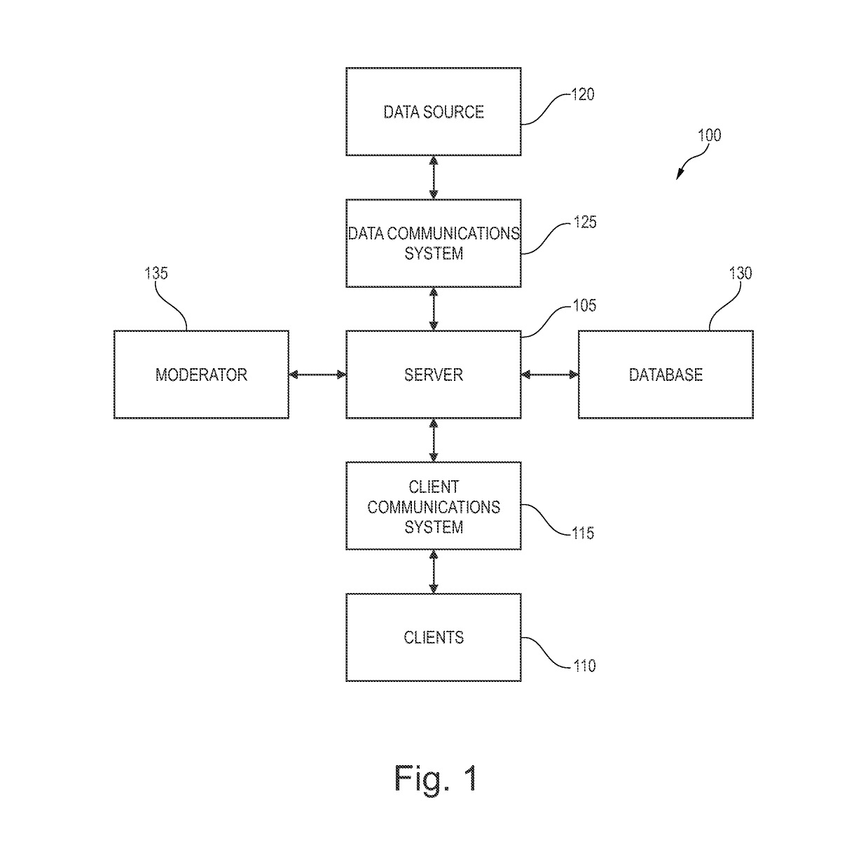

FIG. 1 illustrates a block component diagram for a web-available debate platform 100 including a server 105, a plurality of clients 110, and a client communications system 115 coupling server 105 to clients 110. Platform 100 also includes one or more data sources 120 and a data communications system 125 coupling server 105 to data source 120. Platform 100 additionally includes a database 130 coupled to server 105 and a moderator 135 also coupled to server 105.

Server 105 is implemented as one or more local or distributed, real or virtual machines each having an interface, a processor, and a memory for storing instructions and data. Server 105 may be a server application, operating system, computer, or appliance and may include an application server, a database server, and/or a web server participating in client-server (e.g., web-based) programs and communications) that clients 110 connect to in order to send commands (e.g., HTTP commands and the like) and receive responses along with any data content.

Clients 110 are implemented using electronic computing devices, each having an interface, a processor, and a memory for storing instructions and data. These devices include portable electronic devices and other user computing systems for receiving and displaying content from server 105 as well as composing and sending user contributions to server 105. The content from server 105 may be in any format that may be rendered to user-perceptible format by client 110, including text, audio, video, and the like. The interface also includes one or more mechanisms for the user to contribute content, including typing, speaking, writing, and other interface modalities appropriate to client 110. In some cases, depending upon context, client 110 is referring to an electronic device supporting the functions, and sometimes client 110 is referring to the aggregation of functional elements divorced from the electronic device. Some of this distinction arises because client 110 may be implemented as a specialized device or it may be implemented as an application or suite of applications on the electronic devices through an operating environment, in which case the client is one of several potential processes on the device.

Client communications system 115 and data communications system 125 each represent the communications technology that enable server 105 to create, access, manipulate, and exchange information, particularly with clients 110 and data source 120, respectively. The communications systems are a combination of information technology and communications technology appropriate for the type of content and devices server 105 interfaces to when implementing its functions as described herein. It provides, as necessary or desired, technologies for collaboration, messaging, calendaring, instant messaging, media, text, audio, video, and conferencing, implemented using appropriate technologies including intranet, internet (e.g., the Internet), web, wireless, wired, telephonic, cloud computing, WAN, LAN, and other modalities for exchanging content. Client communications system 115 is shown distinct from data communications system 125 to illustrate that server 105 may not use the same communications technology for exchanging content with clients 110 as it does with data source 120. However, they may both use the same communications technology as well.

Data source 120 represents virtually any public or proprietary source of information accessible by server 105, including news sources, blogs, databases, electronic repositories, and the like. For example, data source 120 includes a news site or data feed that includes current major stories of interest to the users of clients 110.

Database 130 includes organized collection of data for one or more purposes of server 105, clients 110, and moderator 135, usually in digital form. The data are typically organized to model relevant aspects of reality (for example, debates between users of clients 110), in a way that supports processes requiring this information (for example, finding a debate topic and finding others with whom to debate). Database 130 refers both to the way its users view it, and to the logical and physical materialization of its data, content, in files, computer memory, and computer data storage. This definition is very general, and is not to be taken to require any particular type of technology. The data of database 130 is managed to some level of quality (measured in terms of accuracy, availability, usability, and resilience) and this in turn often implies the use of a general-purpose Database management system (DBMS) such as implement, operated, and controlled by server 105. A general-purpose DBMS is typically a complex software system that meets many usage requirements, and the databases that it maintains are often large and complex.

Database 130 represents the data and data structures, and not directly to the DBMS which is a software system used to manage the data. The structure of database 130 is generally too complex to be handled without its DBMS, and any attempt to do otherwise is very likely to result in database corruption. DBMSs are packaged as computer software products: well-known and highly utilized products include the Oracle DBMS, Access and SQL Server from Microsoft, DB2 from IBM and the Open source DBMS MySQL. Each such DBMS product currently supports many thousands of databases all over the world. The stored data in a database is not generally portable across different DBMS, but can inter-operate to some degree (while each DBMS type controls a database of its own database type) using standards like SQL and ODBC. A successful general-purpose DBMS is designed in such a way that it can satisfy as many different applications and application designers as possible. A DBMS also needs to provide effective run-time execution to properly support (e.g., in terms of performance, availability, and security) as many end-users (the database's application users) as needed. The combination of database 130 and its respective DBMS is referred to as a Database system (DBS).

Database 130 is organized according to a general Data models such as one or more of a Relational model (all the DBMS types listed above support databases based on this model), an Entity-relationship model (ERM; primarily utilized to design databases), and an Object model (which has more expressive power than the relational, but is more complicated and less commonly used). Some recent database products use XML as their data model. Database 130 may be viewed for convenience within different data models that are mapped between each other (e.g., mapping between ERM and RM is very common in the database design process, and supported by many database design tools, often within the DBMS itself). Many DBMSs support one data model only, externalized to database developers, but some allow different data models to be used and combined.

Moderator 135 represents both automated and manual systems for moderating debate topics and user content exchanged during debates. Moderation is used to enforce compliance with Terms of Service, Privacy, and improving user experience for those users who wish to have an efficient, vibrant, expansive, and safe forum for exchanging their ideas. Automated moderation is implemented by software processes and may include word filters for screening debate contributions having inappropriate words. Manual moderation includes live moderators who are better equipped to handle moderation tasks less effectively handled by software, such as nuance and patterns of abusive user conduct. The automated moderation is purposefully limited in the preferred embodiment to the nature and types of moderation that may be performed within a matter of a few seconds at most as the exchange of ideas is intended to be a real-time as possible considering that the users are not physically located in the same room with each other and the exchanges take place over various communications systems distributed around the globe. Different users have differing sense of what real-time means, but most consider any delay greater than a few seconds to be unacceptable.

In computer science, real-time computing (RTC), or reactive computing, is the study of hardware and software systems that are subject to a “real-time constraint”—e.g. operational deadlines from event to system response. Real-time programs must execute within strict constraints on response time. By contrast, a non-real-time system is one for which there is no deadline, even if fast response or high performance is desired or preferred. The needs of real-time software are often addressed in the context of real-time operating systems, and synchronous programming languages, which provide frameworks on which to build real-time application software.

A real-time system may be one where its application can be considered (within context) to be mission critical. Real-time computations can be said to have failed if they are not completed before their deadline, where their deadline is relative to an event. A real-time deadline must be met, regardless of system load. A system is said to be real-time if the total correctness of an operation depends not only upon its logical correctness, but also upon the time in which it is performed.

Real-time systems, as well as their deadlines, are classified by the consequence of missing a deadline: Hard, Firm, and Soft. Hard—Missing a deadline is a total system failure; Firm—Infrequent deadline misses are tolerable, but may degrade the system's quality of service and the usefulness of a result is zero after its deadline; and Soft—the usefulness of a result degrades after its deadline, thereby degrading the system's quality of service. Debate platform 100, with respect to exchanges of content between user conjoined into a debate session, is a soft real-time computing system in this aspect as delays in exchanging real-time content exchanges between users degrades the usefulness of the system in an exponential relationship. A goal of platform 100, particularly server 105, clients 110, and client communications system 115 becomes meeting a certain subset of deadlines in order to optimize the exchange of content. The particular criteria optimized depends on the application, but platform 100 preferably includes a goal of maximizing the number of on-time exchanges, minimizing the lateness of delivery, and maximizing the number of high priority tasks to meet these deadlines.

In operation, server 105 polls varies data sources 120 for candidate debate topics of interest to users of clients 110. Server 105 uses an appropriate metric for selecting and ranking candidate debate topics as live debate topics. Server 105 arranges and categorizes them the live debate topics for presentation on the interfaces of clients 110. A user operating its client 110 either selects one of the live debate topics and joins into an existing debate, or creates its own debate topic. Server 105 creates a real-time debate session including all clients 110 whose users have selected a particular debate topic, whether joining the server-created debate topic or a user-created debate topic. Server 105 and client 110 exchange information and content in real-time reflecting each participant's contributions. Moderator 135 moderates these exchanges necessary or desired, also without interfering with the real-time goals. Each user participates in real-time as they choose, accessing topics of interest and contributing as they desire, all within real-time to enhance the user experience which improves engagement and interest.

The specifics of the systems achieving this operation will vary widely. In network environments, such as the Internet, web applications have become popular and are implemented by using a client browser on a web-based network system. When implemented as a web-application, in order to realize the web application, functions are required for generating a web page dynamically at a server in response to a request from a client, e.g. a browser, and sending the web page to the client. As general means for that, there is JSP (Java® Server Pages) which uses Java® (a trademark of Sun Microsystems, Inc., USA) language to realize the dynamic generation of the web page. Other languages are also useable.

There are a very large variety of types of clients connectable to the client communications system and not all clients will be using the same technologies. Therefore, also at the web application, it may be required to execute an appropriate process corresponding to the type of the terminal device which attempts to utilize the web application on server 105. There are differing ways to do this appropriate for the implementation, but in this case, an important objective is maintaining real-time computing status for platform 100 in exchanges of content for ongoing debate sessions. Allocation of resources is preferably dynamic to divert more resources to debate sessions needing more resources to stay real-time. For example, for debate sessions having a large number of users, or when debate content includes more resource-intensive content, server 105 is able to shift resources to maintain real-time status of that debate session.

In a conventional network system, a plurality of devices like server 105 and clients 110 are known to be coupled via a network such as client communications system 115. Software executed by some or all of server 105 and clients 110 establish a client-server relationship among the devices. In this context, a client refers to client software executed on client 110, and a server refers to server software executed on server 105. A single device may execute multiple clients and/or servers.

Using a client, a user accesses data from servers 105 via client communications system 115. When using the client to access data from server 105, the user provide authentication data to server 105 to access the user account. The preferred embodiment does not permit use of anonymous accounts for accessing real-time debate sessions to reduce moderation loads and improve responsiveness of platform 100. When a user wants to access server 105, the client is required to sign on (e.g., provide a username and password) to server 105.

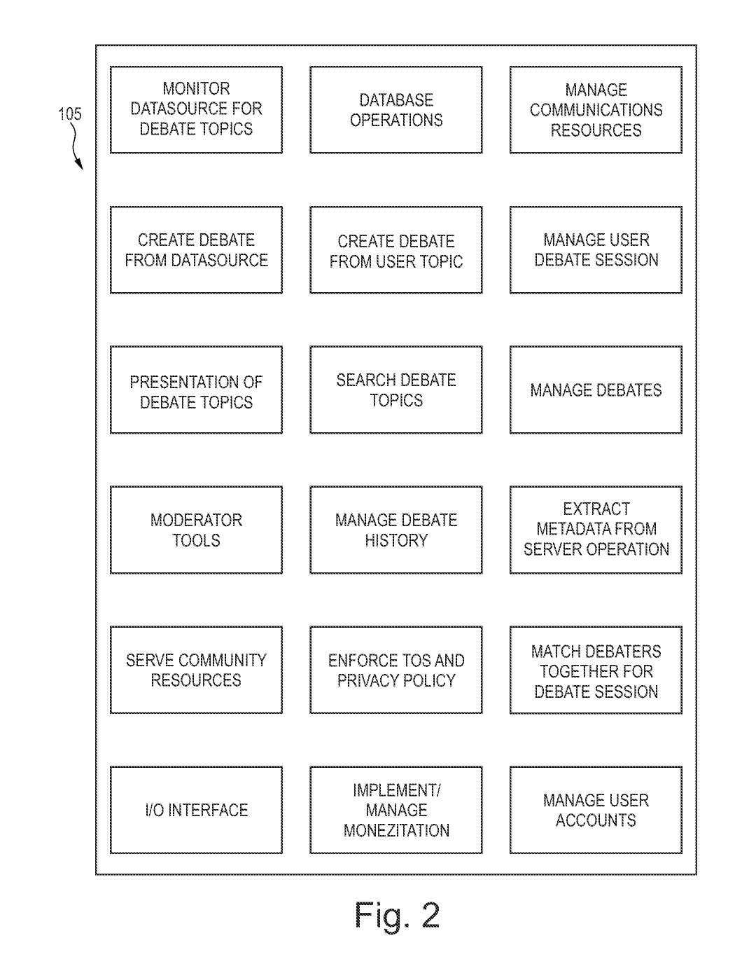

FIG. 2 illustrates a block diagram of functional elements of server 105 included in debate platform 100 shown in FIG. 1. These functional elements include one or more of the following:
Monitor Data Source 120 for Debate Topics: One of the value-add characteristics of platform 100 is providing real-time engagement and one of several ways this is achieved is to provide current debate topics of interest to users. Identifying and monitoring data sources for the latest and most current and relevant debate candidate topics is preferred. Identifying and measuring users interest in topics, platform-created and user-created, is used to identify new relevant topics, such as though related to existing hot topics. Candidate debate topics include news, sports, entertainment, business, religion, politics, food, automotive, and the like, appropriate for the user base. The wider the user base, typically the more diverse and extensive is are the data sources.
Create Debate Topic From Data Source 120: Server 105 creates actual debate topics from candidate debate topics identified from data sources 120. Metrics and other software-implemented algorithms are used to select actual debate topics from candidate debate topics. One metric is simply how many different data sources 120 include references to a particular topic and to select those topics having sufficient level of activity in the data sources. User customization may be achieved by tailoring the data sources and thereby the “hot” topics in the relevant data sources 120 have increased likelihood of being relevant topics for actual debate.
Create Debate Topic From User-Supplied Topic: One of the advantages of platform 100 is that individual users may create actual debate topics for consideration by other users.
Database 130 Operations: Server 105 is responsible for managing database 130. The specifics of the management depend upon the database implementation, data, and database type. Database 130 stores information relevant to individual users (e.g., account information), to debate topics and debate sessions (ongoing and completed), to monetization strategies, and to most other server operations as well.
Manage User Debate Session: Server 105 manages ongoing debate sessions for resource requirements, any expiration deadline (e.g., in the preferred embodiment, to maintain relevance and freshness, a debate session has a hard deadline from a time that it is initiated to when it expires (e.g., a preset number of hours). Users can recreate a new debate session from the same or related topic and thus help ensure that the debate remains fresh.
Manage Communications Resources: As noted herein, there are a wide range of potential communications resources that server 105 may employ. The specifics are dependent upon the technologies used by clients and technologies needed to access the desired data sources 120. Platform 100 is designed to permit users to access debate topics and participate in debates using whatever technologies are most convenient for them from their personal computer, laptop, tablet, smartphone, or other electronic device, portable or fixed, using text, audio, video, text-messaging, voice, or other technologies.
Presentation of Debate Topics: Server 105 arranges actual debate topics to facilitate users locating topics of interest. The specifics of the arrangement and presentation are implementation-specific. In a preferred embodiment, actual topics are arranged into appropriate categories and “hottest” topics are arranged in a hierarchy according to server selection procedures. User-created topics are also arranged for presentation to users and categorized/arranged. The method of presentation/arrangement may also include several different modalities, including a scrolling list of ongoing debates. A feature of the preferred embodiment is to have cues, e.g., visual elements, associated with topics to reflect how hot/current the topic is. For example, topics may fade over time or fade based upon number of participants.
Search Debate Topics: Server 105 also provides users with an alternative to finding actual debate topics of interest other than selection from a list or other control. A user is enabled to search for desired debate topics. As the number of users and actual debate topics increase, it is advantageous for server 105 to include a search feature, to find actual debate topics by category, number of participants, time, category, and the like.
Manage Debates: Server 105 not only determines debate topics and establishes and configures debate sessions between two or more clients 110, server 105 manages ongoing debates sessions. Server 105 provides any needed additional resources, interfaces to moderator tools, and performs any needed or desirable logging, archiving, and/or metadata extraction or the like. There are various debate session status flags associated with debate sessions that are implemented and managed/enforced by server 105. For example, some of the status flags may relate to privacy (a non-public debate), access list of persons able to access a particular debate, flags as to whether the debate session is archived. Other status information may also be implemented specific to platform 100 requirements.
Moderator Tools: Server 105 implements moderator tools used by moderator 135 for moderation of debate sessions and user accounts. The tools include redaction/alteration of content in a debate session, suspension of ongoing debate sessions, such as for inappropriate debate topics in violation of the Terms of Service, and status information associated with user accounts.
Manage Debate History: Server 105 of the preferred embodiment maintains a history archive of non-confidential debate sessions. In some embodiments, this history archive is searchable, based upon desired criteria, including topic, category, number of users, specific user, or other parameter.
Extract Metadata from Server Operations: As noted above, and in other instances, server 105 extracts metadata from various server operations and functions. In addition to measuring user interest and using that interest to select additional debate topics, other data mining of users, sessions, topics, categories and the like, particularly when matched and processed in compliance with privacy policy and user demographics, new services, topics, features, and functions are provided to users. Being a real-time platform, the extraction and use of the metadata may sometimes be immediate, or based upon longer term cycles, user interest, and other operational parameters to enhance platform 100. The metadata may also be used to link to monetization functions, including tailoring monetization activities to user individual and collective interests.
Serve Community Resources: Server 105 includes some non-real-time services and resources for users, with those resources identified herein as “community” resources. They may include job postings, dating services, classified ads, housing, and other resources useful to the community of users. Preferably these are made available in a non-priority basis without impacting the real-time functions of platform 100, and may be implemented similarly to more conventional web applications. These resources may provide some candidate debate topics so are monitored by server 105 as a data source 120.
Enforce ToS and Privacy Policy: Platform 100 requires implementation of

Terms of Service and a Privacy Policy. Server 105 includes functions designed and implemented to enforce the ToS and Privacy Policies.
Match Debaters Together for Debate Session: Server 105 performs the resource allocation and overhead management to match potential debaters and to create each debate session. A user may make themselves available with a “Debate Me Now” flag, which may include a suggested debate topic (e.g., “Why the San Francisco Giants Will Repeat as Champions” or debate category (e.g., Major League Baseball), or other specific or general indicia. Server 105 will make this availability known in appropriate fashion to the community at large, users interested in those topics, debate associates of the user, or other filtered group.
I/O Interface: Server 105 of the preferred embodiment has minimal need for an extensive I/O interface, particularly as many of the functions are back-end services accessible through clients 110, particularly interfaces of clients 110. However, any needed I/O needs are handled by server 105.
Manage User Accounts: Server 105 manages the creation and ongoing overhead for enabling users to access and change their accounts. Login credentials and any customizations are set, applied, and changed through the user account management. User preferences and other details are implemented from these values.
Implement/Manage Monetization: In the preferred embodiment, server 105 manages monetization strategies which may include, as appropriate, advertising, fees for placing and/or accessing various community resources, fees for accessing or responding to the extracted metadata, premium services/features, copies of various content, and other strategies.

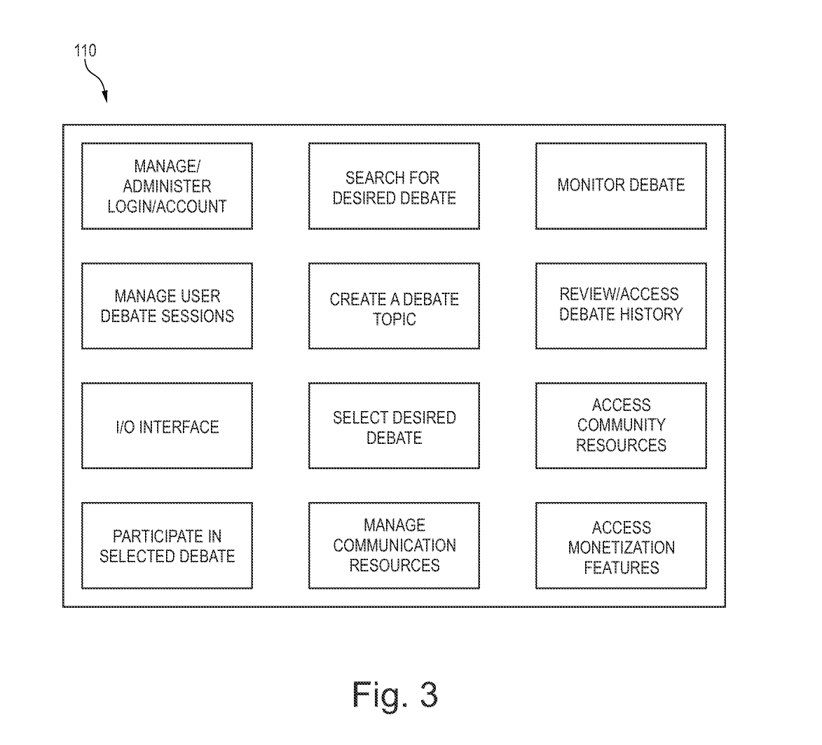

FIG. 3 illustrates a block diagram of functional elements of the client included in the debate platform shown in FIG. 1. These functional elements include one or more of the following which typically has a complementary functional element in server 105:
I/O Interface: One of the principle functional elements for client 110 as it renders content from server 105 in a form suitable for consumption by a user (e.g., a visual display or speaker) and permits a user to interact with server 105 (e.g., typing, speaking, or otherwise generating a user response or user content) responsive to the server content. Different clients 110 may use different interfaces and the nature of the interface may be at least partially determined by the nature of the electronic device supporting client 110 and the I/O interface. In some cases, the electronic device includes interface resources that may be used in cooperation with client 110, such as a voice-aware operating system. In which case, client 110 may not need to provide that interface element when needed or desired. An important aspect of the I/O interface is that it supports dynamic content (e.g., scrolling text or other rendered (e.g., audibilized or visualized) streaming server content) as one form of participation in a real-time debate. The user does not refresh or perform other action to obtain the latest content from server 105.
Manage/Administer Login/Account: Client 110 provides the mechanisms for a user to access their account on server 105. These mechanisms include account credential and user verification such as, for example, username and password. Client 110 preferably provides, through the I/O interface, a mechanism to access and change the credentials, as well as review and set user options.
Search for Desired Debate: Client 110 enables the user to implement the search feature described herein to actually find a desired debate.
Monitor Debate: Client 110 in some cases allows a user to monitor a debate session separate and apart from actually participating in a given debate session. For example, a user may not want to participate in a debate until a particular number of users are present and active in a debate session. (For example, only participate if there are more than 4 users, or wait to jump into an active debate session until the number of users falls below 5 users.) Server 105 may information about the ongoing debate sessions available and client 110 is used to monitor them for purposes important to the users.
Manage User Debate Session: Client 110 is responsible for its part in establishing and maintaining an ongoing real-time debate session. This function reflects that physical and logical layers for accessing and configuring resources of the electronic device supporting client 110 to enable real-time debate. Additionally, this function releases resources when a user's participation in a session end. As noted herein, real-time is a priority in the preferred embodiment so a function is devoted to ensuring suitable resources are made available to help ensure that a suitable responsiveness for the debate session is achieved. In a preferred embodiment, communications between clients 110 of a conjoined debate session are in a “client-server” architecture. That is, communications between clients are passed through server 105, with messages repeated from server 105 to all conjoined clients of an active debate session. Server 105 acts as a central hub for exchanges of content. Another architecture mode is a peer-to-peer architecture in which server 105 facilitates clients 110 forming direct links to other clients 110 when exchanging debate content. Server 105 could participate as a passive peer.
Create a Debate Topic: Client 110, through the I/O interface, enables each user to create debate topics and have those topics available to others users accessing server 105.
Review/Access Debate History: In some embodiments, users are provided access to some or all of the debate history logged by server 105. The access preferably includes search features in addition to other forms of accessing and reading the history. Some of the specifics of the access is determined by how the history is recorded and maintained, as well as what data is recorded.
Select Desired Debate: As noted herein, server 105 arranges a presentation format for actual debate topics and client 110 renders that presentation for the user. The user is able thereafter to select, in some fashion appropriate to the user I/O interface of client 110, one of the debate topics for participation.
Access Community Resources: Client 110 allows access to the community resources presented by server 105. For example, through a “web browser” process or the like. The user is able to identify, review, and interact with the community resources as appropriate for the type of resource and interaction methods allowed by server 105.
Participate in Selected Debate: Client 110 allows a user to participate in the selected debate topic by receiving streaming real-time content from server 105 that represents other contributions from other users joined into the same real-time debate session. Similarly, contributions from the user are passed from client 110, to server 105, to other participants. In some situations such as when server 105 has facilitated the clients 110 of the debate session participants forming a peer-to-peer debate session, communicates are exchanged directly with other clients 110 joined into the debate session. Server 105 may participate as a passive peer in such cases as necessary or desired, such as for moderation, archiving, or metadata extraction or other server function.
Manage Communication Resources: As noted herein, there are a wide range of potential communications resources that clients 110 may employ. The specifics are dependent upon the technologies used by server 105, the electronic device supporting client 110, and technologies needed to communicate with other devices. Platform 100 is designed to permit users to access debate topics and participate in debates using whatever technologies are most convenient for them from their personal computer, laptop, tablet, smartphone, or other electronic device, portable or fixed, using text, audio, video, text-messaging, voice, or other technologies.
Access Monetization Features: Some monetization strategies include access to various monetization resources (an advertiser url for example) by the user, or at least visualization of an advertisement. Client 110 facilitates the user-related monetization strategies of platform 100.

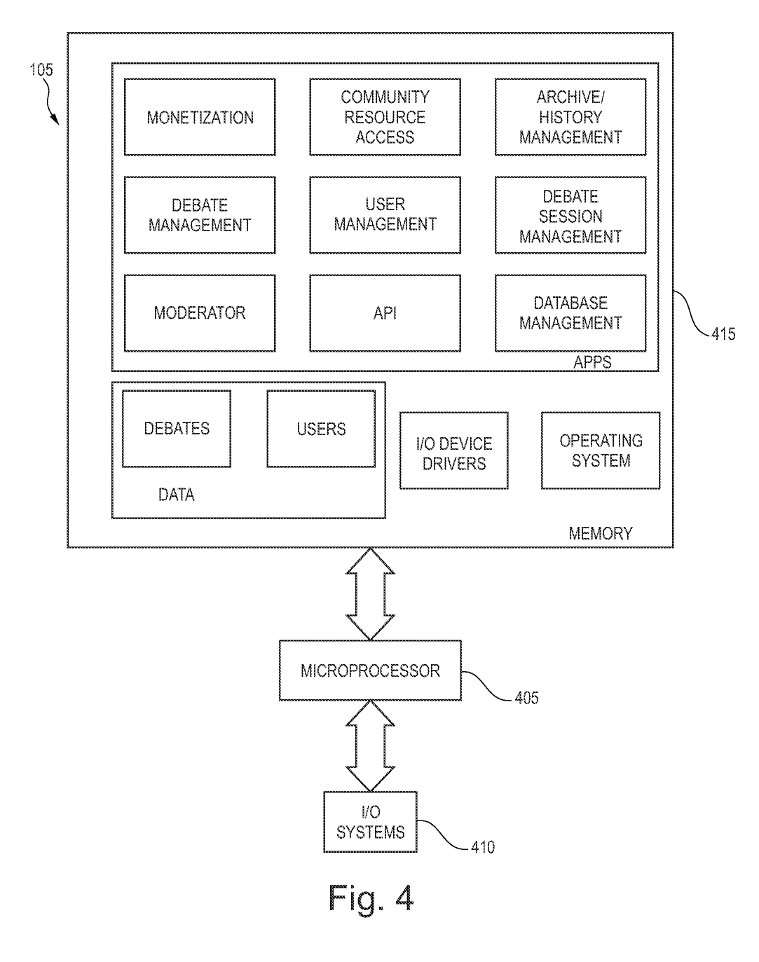

FIG. 4 illustrates a block diagram of the hardware elements of server 105 included in debate platform 100 shown in FIG. 1. Server 105 includes a microprocessor 405 coupled to both I/O systems 410 and a memory 415. Microprocessor 405 incorporates the functions of a central processing unit (CPU) on one or more integrated circuits (IC, or microchip). Microprocessor 405 includes is a multipurpose, programmable, clock-driven, register-based electronic device that accepts digital data as input, processes it according to instructions stored in its memory, and provides results as output. It is an example of sequential digital logic, as it has internal memory, i.e. its registers. Microprocessor 405 encompasses concepts such as microcontroller, processor, CPU, controller, and the like.

Input/output systems, or I/O systems 410, refers to the communication mechanisms between server 105, and the outside world, possibly a human, or another information processing system, device, process, or function. Inputs are the signals or data received by the system, and outputs are the signals or data sent from it. The term can also be used as part of an action; to “perform I/O” is to perform an input or output operation. I/O devices are used by a person (or other system) to communicate with a computer. For instance, a keyboard or a mouse may be an input device for a computer, while monitors and printers are considered output devices for a computer. Devices for communication between computers, such as modems and network cards, typically serve for both input and output.

Note that the designation of a device as either input or output depends on the perspective. Mouse and keyboards take as input physical movement that the human user outputs and convert it into signals that a computer can understand. The output from these devices is input for the computer. Similarly, printers and monitors take as input signals that a computer outputs. They then convert these signals into representations that human users can see or read. For a human user the process of reading or seeing these representations is receiving input.

The combination of microprocessor 405 and main memory 415 (i.e. memory that processor reads and writes to directly, with individual instructions) is considered the brain of server 105, and from that point of view any transfer of information from or to that combination, for example to or from a disk drive, is considered I/O. Microprocessor 405 and its supporting circuitry provide memory-mapped I/O that is used in low-level computer programming in the implementation of device drivers. An I/O algorithm is one designed to exploit locality and perform efficiently when data reside on secondary storage, such as a disk drive.

Memory 415, includes what is sometimes referred to as main memory, is directly accessible to microprocessor 405. Microprocessor 405 continuously reads instructions stored there and executes them as required. Any data actively operated on is also stored there in uniform manner. Memory includes magnetic media, semiconductor media (e.g., RAM, ROM, and like),

Memory 415 is directly or indirectly connected to microprocessor 405 via a memory bus 420. Bus 420 actually includes two buses: an address bus and a data bus. Microprocessor 415 firstly sends a number through an address bus, a number called memory address, that indicates the desired location of data. Then it reads or writes the data itself using the data bus. Additionally, a memory management unit (MMU) is a small device between microprocessor 405 and memory 415 recalculating the actual memory address, for example to provide any abstraction of virtual memory or other tasks as needed.

As some elements of memory 415, such as that used for primary storage, are volatile (cleared at start up), memory 415 also includes one or more types of non-volatile primary storage containing a small startup program (BIOS) is used to bootstrap server 105, that is, to read a larger program from non-volatile secondary storage of memory 415 to primary storage of memory 415 and start to execute it. A non-volatile technology used for this purpose is called ROM, for read-only memory.

Many types of “ROM” are not literally read only, as updates are possible; however it is slow and memory must be erased in large portions before it can be re-written. Some embedded systems run programs directly from ROM (or similar), because such programs are rarely changed. Standard computers do not store non-rudimentary programs in ROM, rather use large capacities of secondary storage, which is non-volatile as well, and not as costly.

Memory 415 includes such secondary storage (also known as external memory or auxiliary storage), that differs from primary storage in that it is not directly accessible by microprocessor 405. Server 105 usually uses its input/output channels to access secondary storage and transfers the desired data using intermediate area in primary storage. Secondary storage does not lose the data when the device is powered down—it is non-volatile. Per unit, it is typically also two orders of magnitude less expensive than primary storage. Consequently, modern computer systems typically have two orders of magnitude more secondary storage than primary storage and data is kept for a longer time there. Memory 415 may include hard disk drives and rotating optical storage devices, such as CD and DVD drives, as secondary storage. Some other examples of secondary storage technologies are: flash memory (e.g. USB flash drives or keys), floppy disks, magnetic tape, paper tape, punched cards, standalone RAM disks, and Iomega Zip drives.

Server 105 may employ the concept of virtual memory, allowing utilization of more primary storage capacity than is physically available in the system. As the primary memory fills up, the system moves the least-used chunks (pages) to secondary storage devices (to a swap file or page file), retrieving them later when they are needed. As more of these retrievals from slower secondary storage are necessary, the more the overall system performance is degraded.

FIG. 4 shows an arrangement of memory 415 into different portions including an operating system, I/O device drivers, data, and applications. The operating system (OS) is typically software, including programs and data, that executes on server 105 using microprocessor 405. The operating system manages computer hardware resources, and provides common services for execution of various application software. The operating system is an important type of system software in server 105.

For hardware functions such as input and output and memory allocation, the operating system acts as an intermediary between application programs and the computer hardware although the application code is usually executed directly by the hardware and will frequently call the OS or be interrupted by it. Examples of popular modern operating systems include BSD, Linux, Mac OS X, Microsoft Windows, and Unix and the like.

The device drivers are computer programs allowing higher-level computer programs to interact with a hardware device and typically there is a device driver for each hardware system. The driver typically communicates with the device through the computer bus or communications subsystem to which the hardware connects. When a calling program invokes a routine in the driver, the driver issues commands to the device. Once the device sends data back to the driver, the driver may invoke routines in the original calling program. Drivers are hardware-dependent and operating-system-specific. They usually provide the interrupt handling required for any necessary asynchronous time-dependent hardware interface.

Memory 415 includes components storing necessary data, including information regarding debates and users. Server 105 may access database 130 to transfer some information into and out of memory 415 during operation. Memory 415 also includes a portion storing the applications (also processes or programs) that implement the functional elements described herein with the operation of server 105 and its interaction with clients 110. Those applications include one or more of monetization, community resource access, archive/history management, debate management, user management, debate session management, moderator tools, database management, and an application programming interface (API).

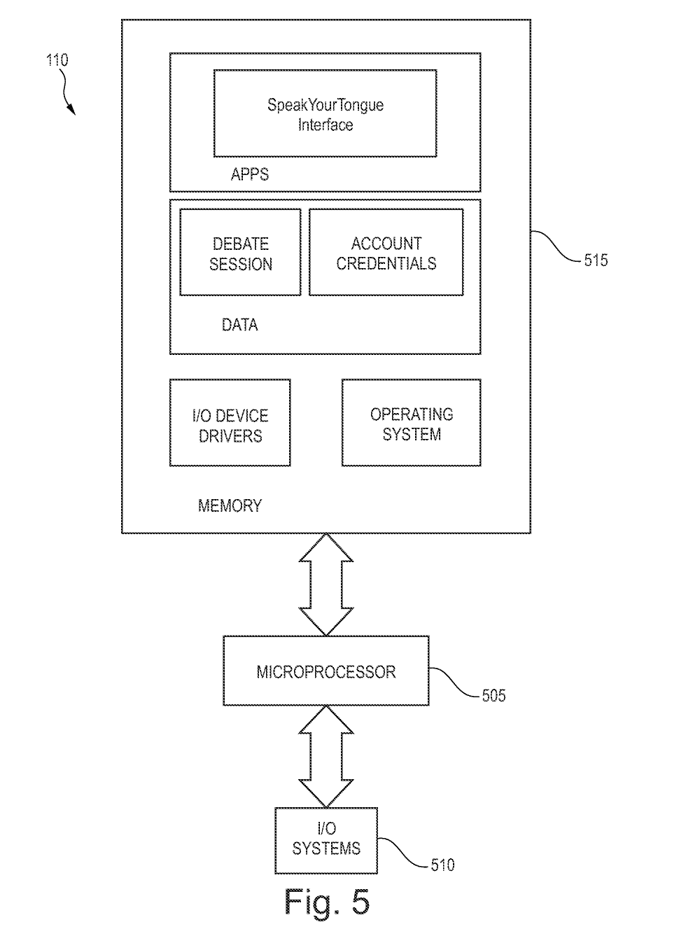

FIG. 5 illustrates a block diagram of hardware elements of client 110 included in debate platform 100 shown in FIG. 1. Client 110 includes a microprocessor 505 coupled to both I/O systems 510 and a memory 515. With the understanding that the specifics of microprocessor 505, I/O systems 510, and memory 515 are appropriate for a client role than for a server role, at one level of abstraction microprocessor 505 is similar to microprocessor 405, I/O systems 510 are similar to I/O systems 410, and memory 515 is similar to memory 415. Microprocessor 505 is selected and implemented appropriately for its role as a controller in an electronic device supporting the client functions rather than the server functions. I/O systems 510 are appropriate for the interface systems of the electronic device and client rather than the server. Memory 515 is similar in general, but varies in the particular arrangement and content. For example, memory 515 will typically include an OS appropriate for a client device, for example Android, iOS, Symbian, Palm, Blackberry, Windows CE/Phone 7, MeeGo, and Bada and the like, in addition to BSD, Linux, Mac OS X, Microsoft Windows, and Unix and the like.

Client 110 of the preferred embodiment has reduced requirements for storage of data (e.g., particular debate session(s) the user is active and some account credentials as needed to maintain an active link to server 105) and application. The application portion of memory 515 includes one or more client applications accessing and implementing the desired functions and features of server 105, including visualization, selection, searching, creation and participation of debate topics and debate sessions.

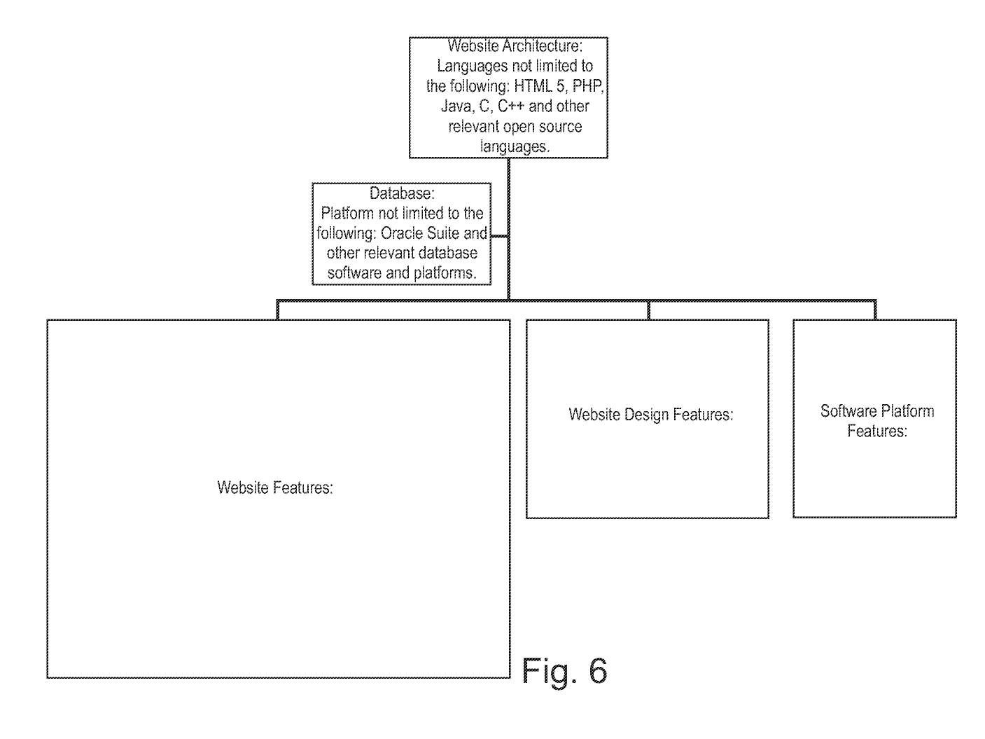

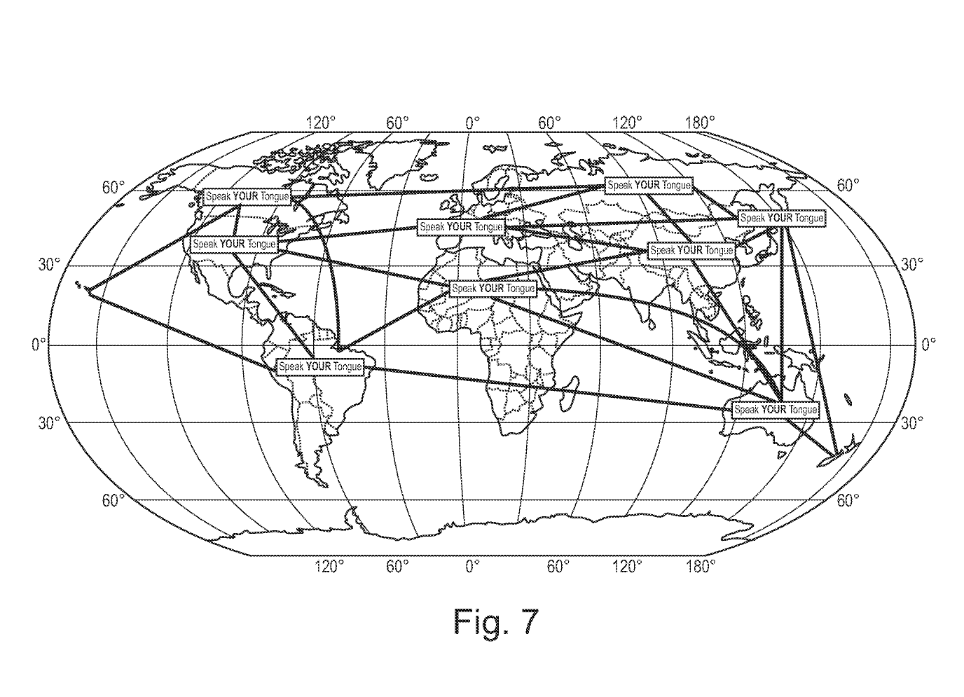

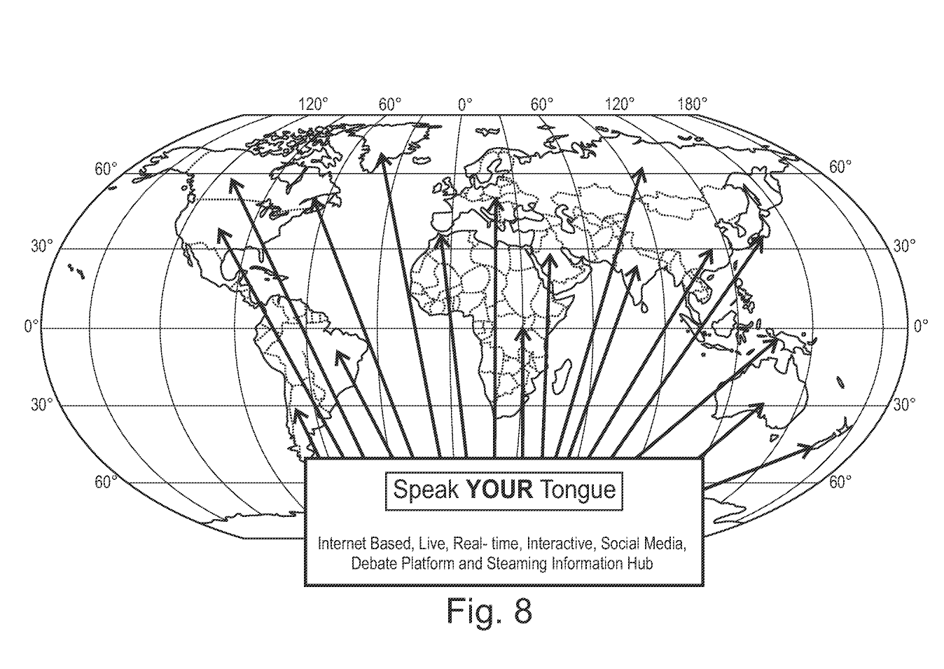

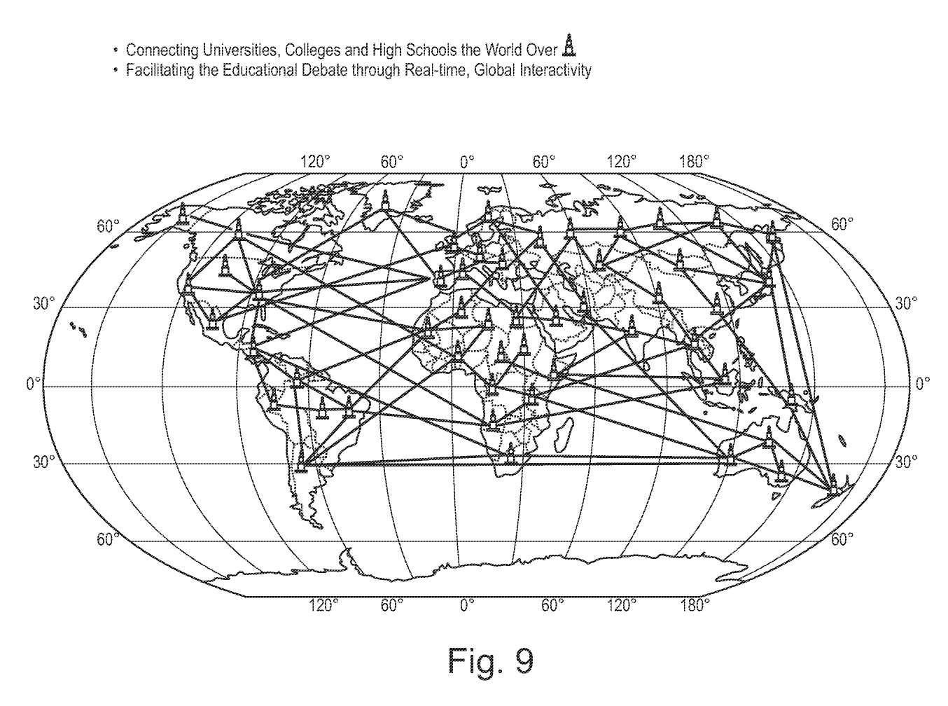

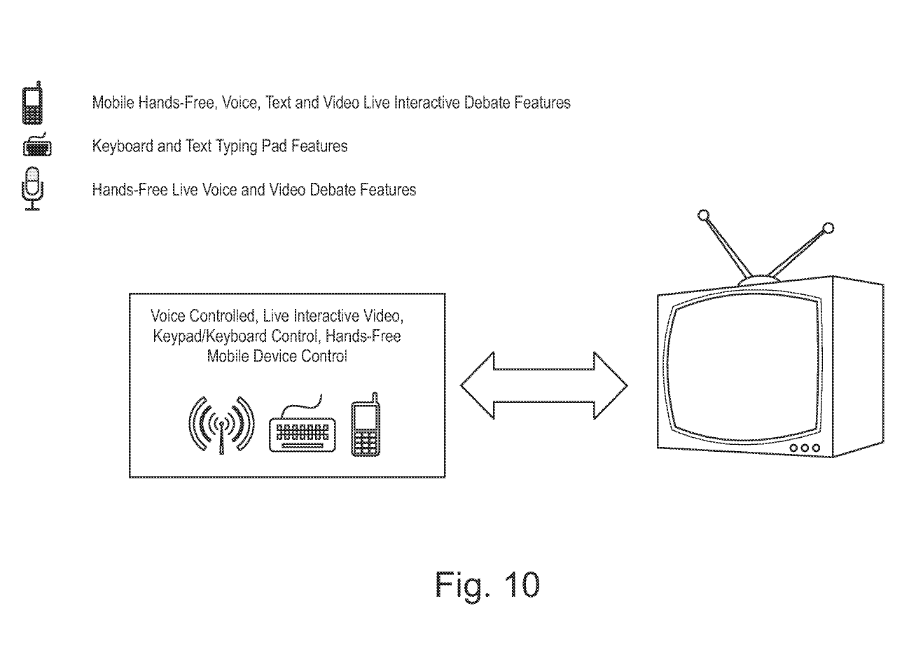

FIG. 6 illustrates a representative architecture for a preferred implementation. A website architecture includes a database, website features, website design features, and software platform features. Some of these features are further explained in FIG. 7 through FIG. 10. FIG. 7 through FIG. 10 illustrates a functional description of architecture features shown in FIG. 6.

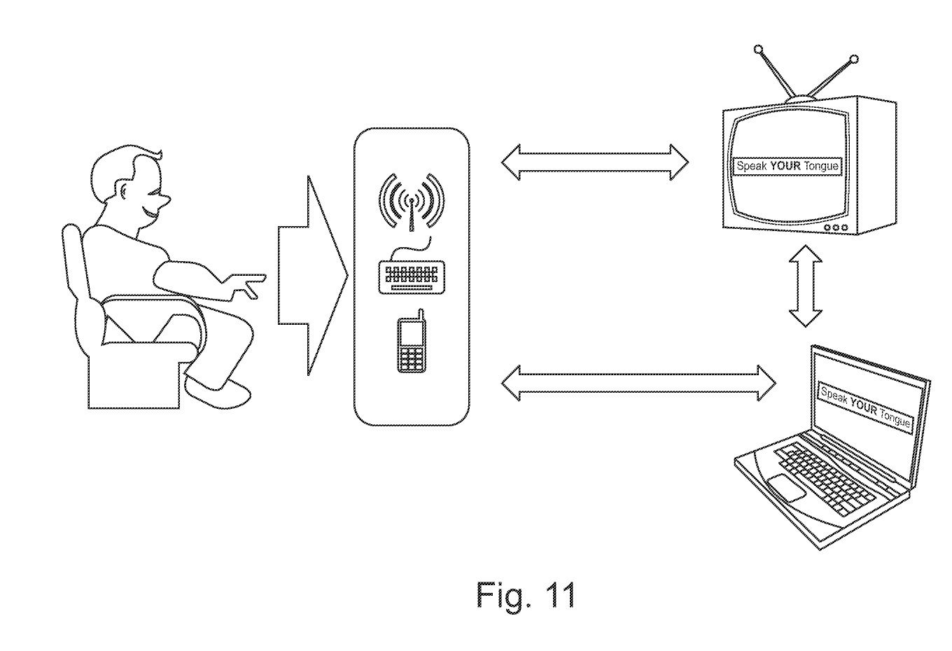

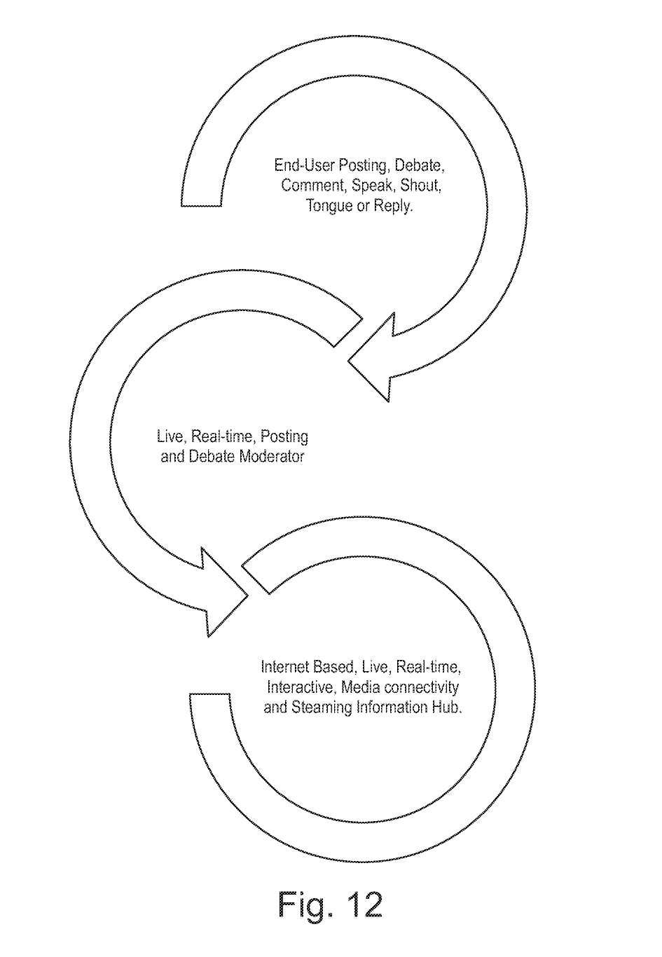

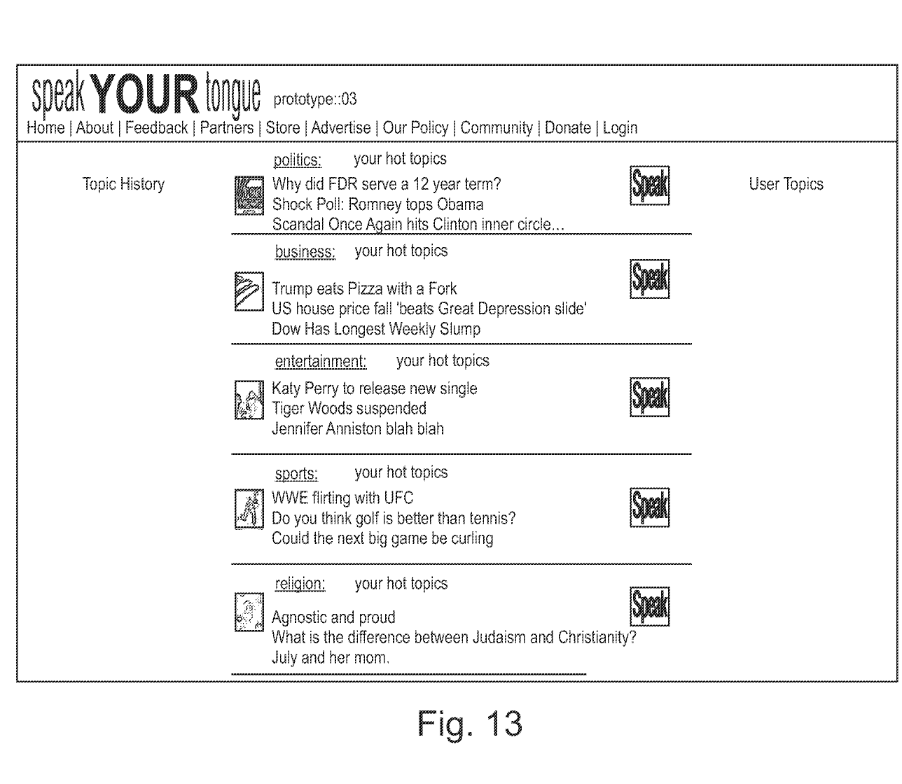

FIG. 11 illustrates global connectivity for debate platform 100 shown in FIG. 1. Features and benefits of the connectivity are further described in FIG. 11 and herein. FIG. 12 illustrates representative global TV and Media integration, among other features, for debate platform 100 shown in FIG. 1. FIG. 13 illustrates representative educational institution integration for debate platform 100 shown in FIG. 1.

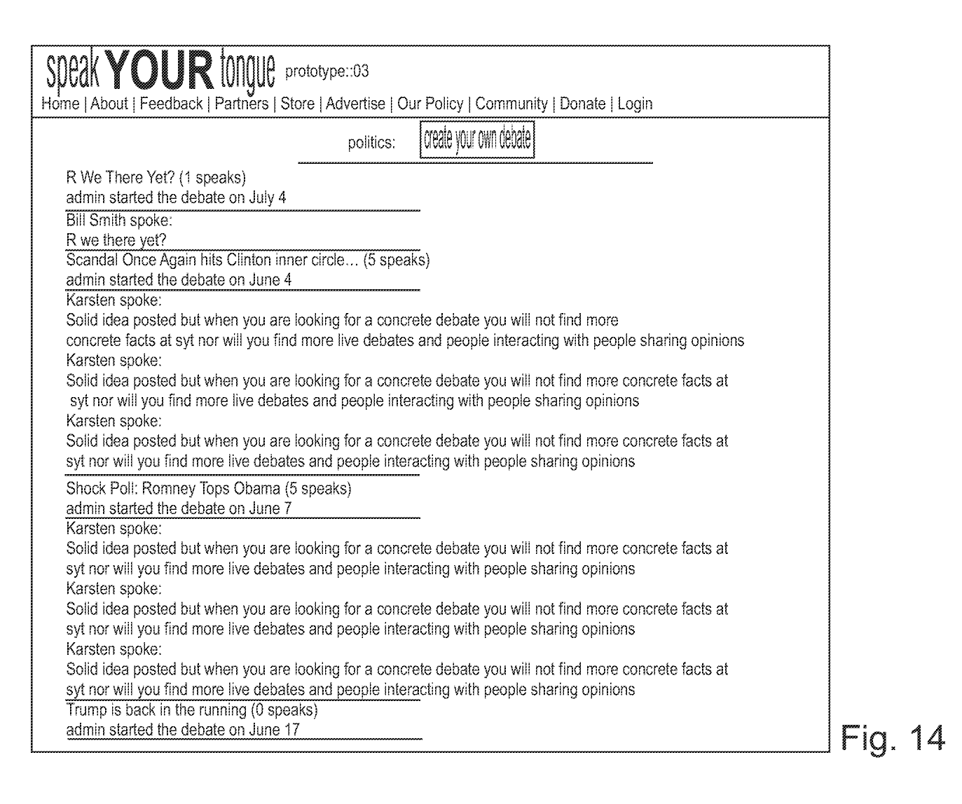

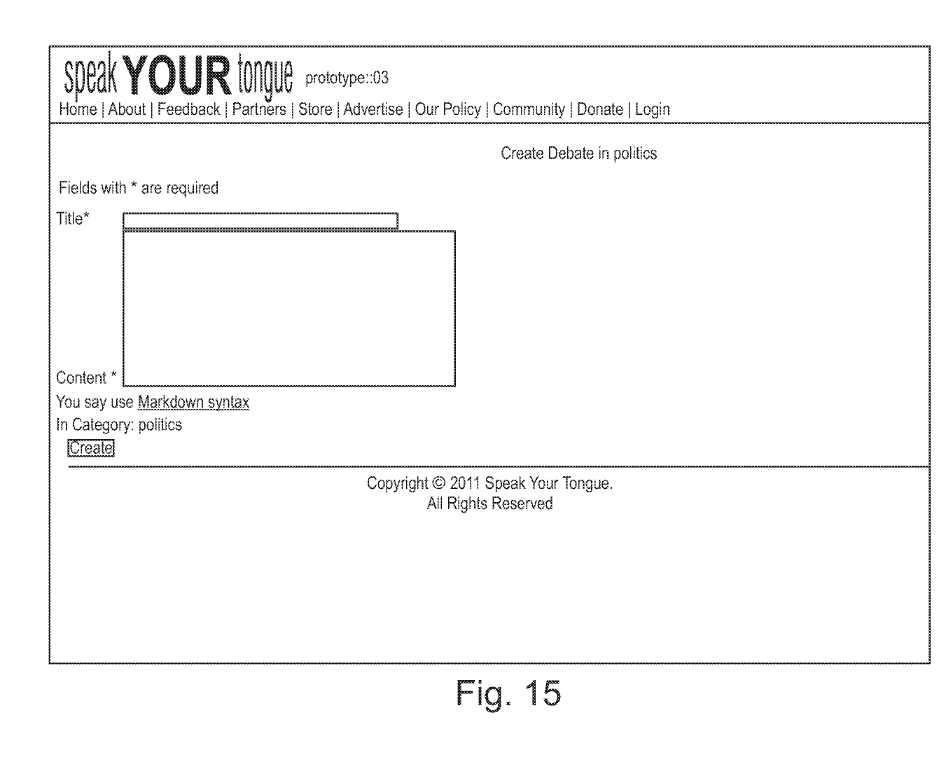

FIG. 14 illustrates representative I/O interface implementation for debate platform 100. Multimodal interactivity and interface elements are described and shown. FIG. 15 illustrates representative I/O interface implementation for debate platform 100.

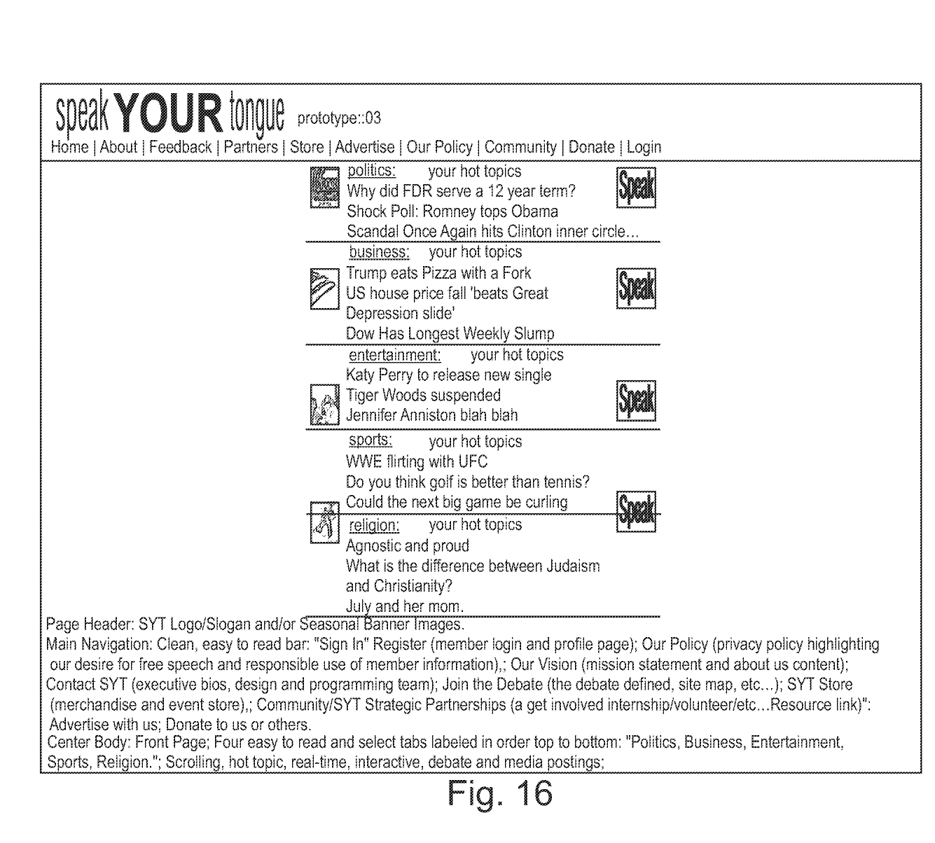

FIG. 16 illustrates a live, real-time posting and moderator(s) feature diagram. A debate moderator is shown between an end-user post into a debate session and streaming of that post for other users in the debate session.

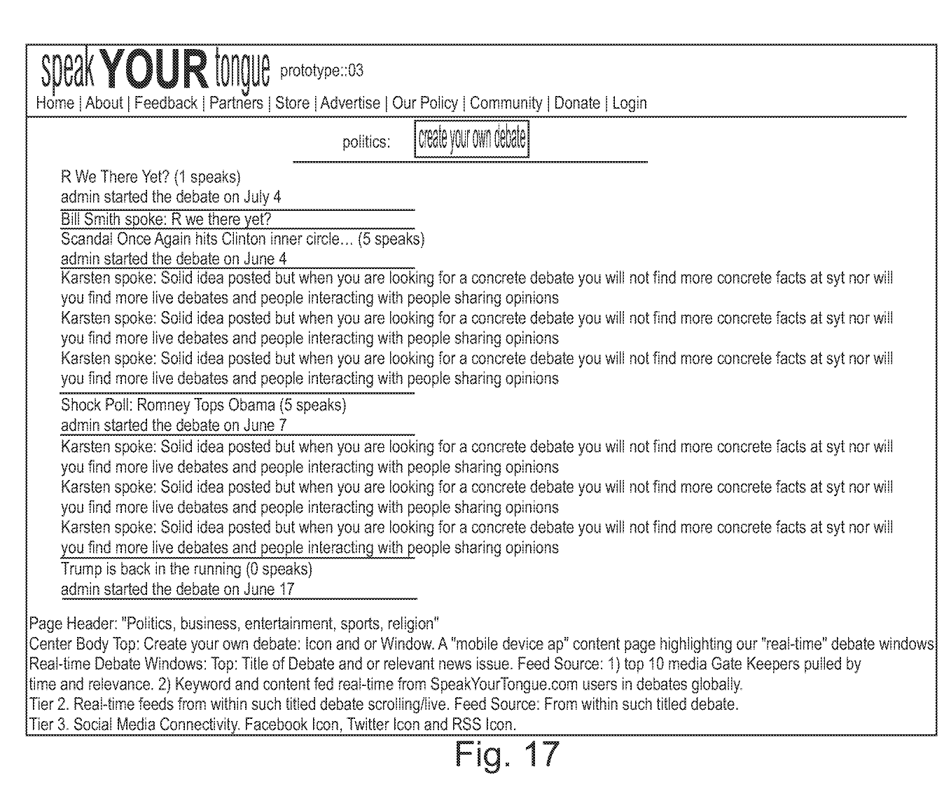

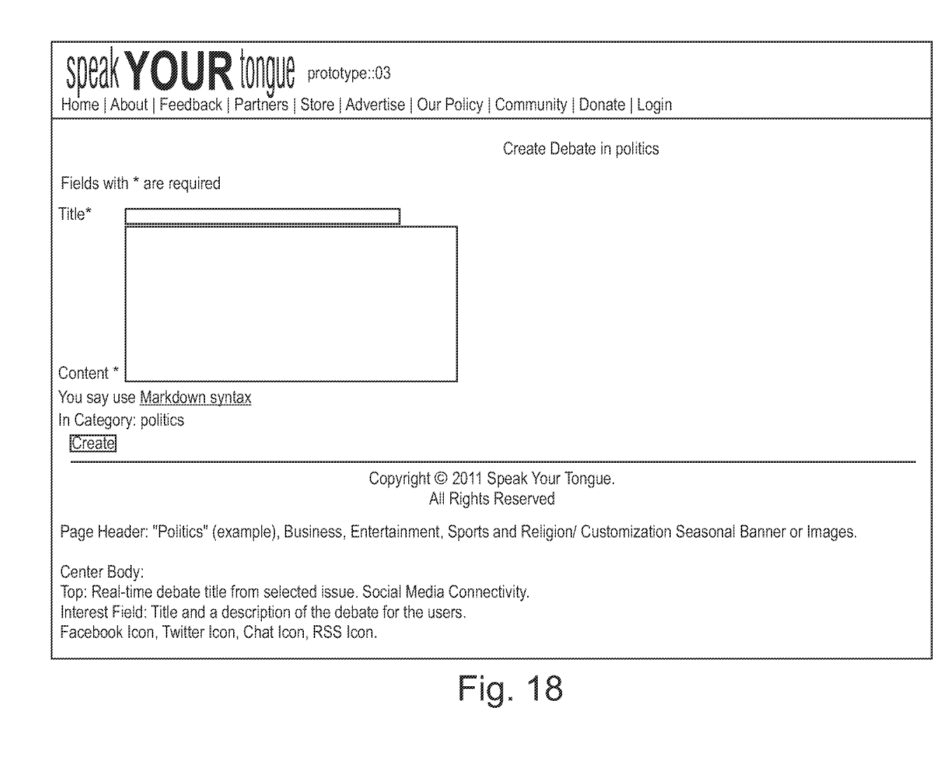

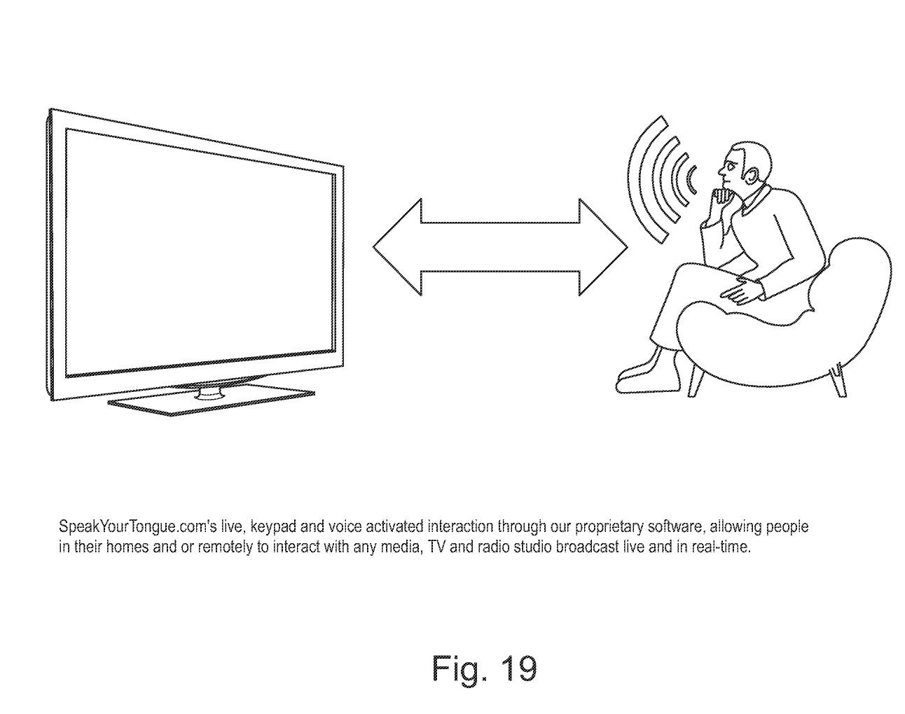

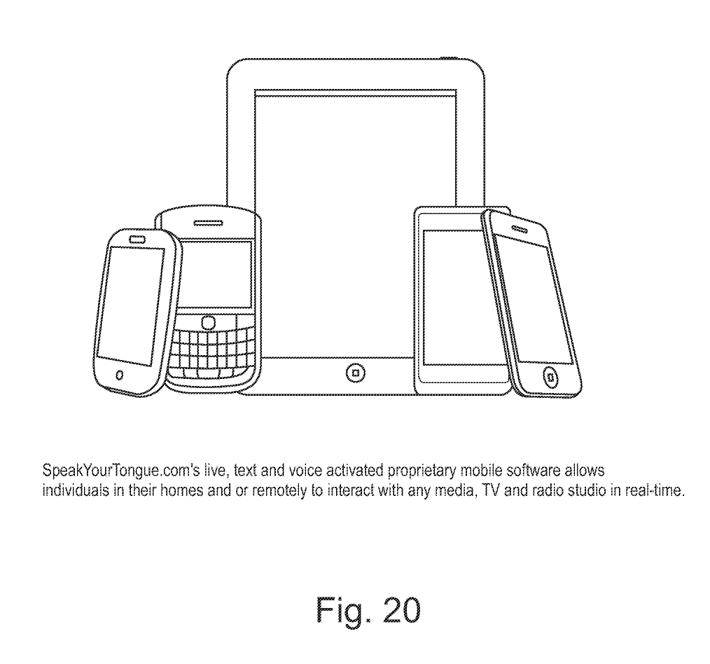

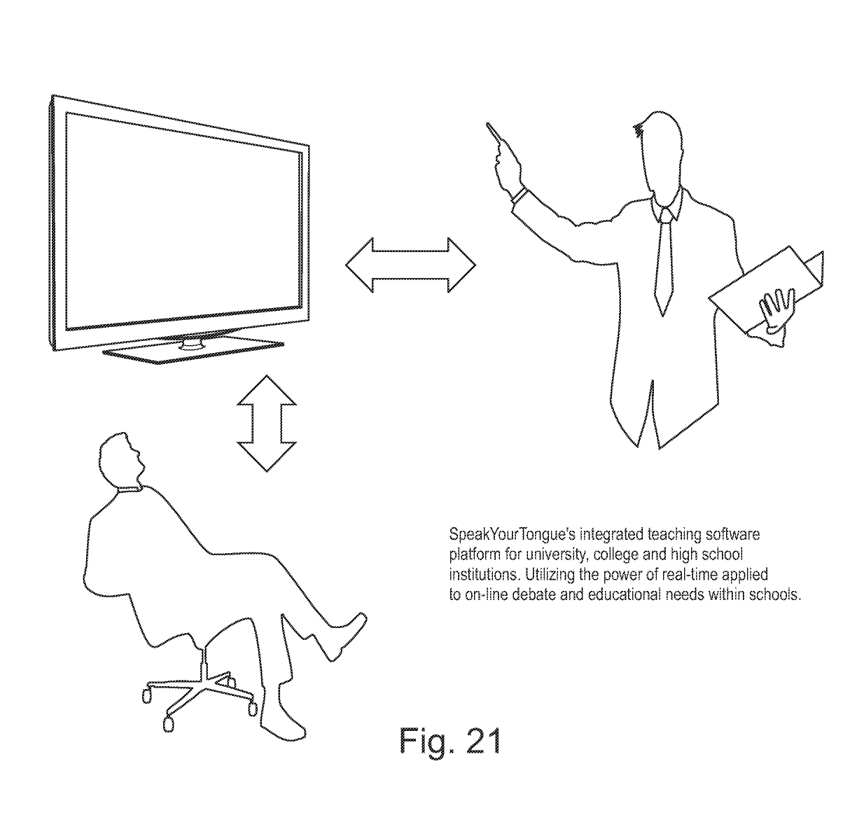

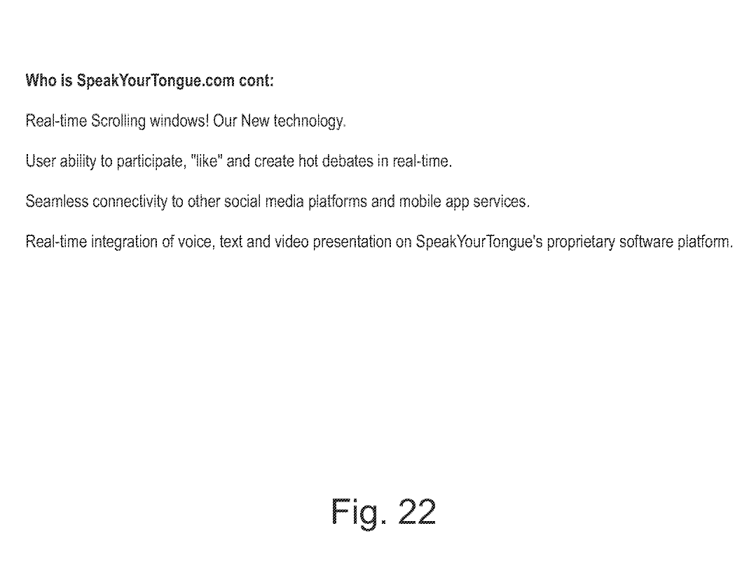

FIG. 17 illustrates a representative main page for a preferred implementation including server and user created topics and a topic history of debate platform 100 shown in FIG. 1. FIG. 18 illustrates a representative child page for one of the debate categories of debate platform 100 shown in FIG. 1. FIG. 19 illustrates a representative child page for user debate topic creation using platform 100 shown in FIG. 1. FIG. 20 illustrates additional details of representative main page shown in FIG. 17. FIG. 21 illustrates additional details of representative child page shown in FIG. 18. FIG. 22 illustrates additional details of representative topic creation page shown in FIG. 19. These are representative controls for realizing a particular preferred embodiment. Other controls and arrangements will be used for other embodiments and implementations.

FIG. 23 illustrates real-time connectivity and integration for debate platform 100 shown in FIG. 1. FIG. 24 illustrates additional interface details for debate platform 100 shown in FIG. 1. FIG. 25 illustrates additional educational integration details for debate platform 100 shown in FIG. 1. FIG. 26 illustrates features of a preferred implementation of debate platform 100 shown in FIG. 1.

The system, method, and computer-program product above has been described in the preferred embodiment including a suitably programmed general purpose computer, real, virtual, and/or cloud-based, including a processing unit executing instructions read from a memory, controlled using one more user interfaces, with the memory being local or remote to the system, and in some cases a wired/wireless interconnection with other computing systems for the access/sharing/aggregation of data. In some embodiments, the devices communicate via a peer-to-peer communications system in addition to or in lieu of Server/Client communications.

The system, method, and computer program product, described in this application may, of course, be embodied in hardware; e.g., within or coupled to a Central Processing Unit (“CPU”), microprocessor, microcontroller, System on Chip (“SOC”), or any other programmable device. Additionally, the system, method, computer program product, and propagated signal may be embodied in software (e.g., computer readable code, program code, instructions and/or data disposed in any form, such as source, object or machine language) disposed, for example, in a computer usable (e.g., readable) medium configured to store the software. Such software enables the function, fabrication, modeling, simulation, description and/or testing of the apparatus and processes described herein. For example, this can be accomplished through the use of general programming languages (e.g., C, C++), GDSII databases, hardware description languages (HDL) including Verilog HDL, VHDL, AHDL (Altera HDL) and so on, or other available programs, databases, nanoprocessing, and/or circuit (i.e., schematic) capture tools. Such software can be disposed in any known computer usable medium including semiconductor, magnetic disk, optical disc (e.g., CD-ROM, DVD-ROM, etc.) and as a computer data signal embodied in a computer usable (e.g., readable) transmission medium (e.g., carrier wave or any other medium including digital, optical, or analog-based medium). As such, the software can be transmitted over communication networks including the Internet and intranets. A system, method, and computer program product embodied in software may be included in a semiconductor intellectual property core (e.g., embodied in HDL) and transformed to hardware in the production of integrated circuits. Additionally, a system, method, and computer program product as described herein may be embodied as a combination of hardware and software.

One of the preferred implementations of the present invention is as a routine in an operating system made up of programming steps or instructions resident in a memory of a computing system as well known, during computer operations. Until required by the computer system, the program instructions may be stored in another readable medium, e.g. in a disk drive, or in a removable memory, such as an optical disk for use in a CD ROM computer input or in a floppy disk for use in a floppy disk drive computer input. Further, the program instructions may be stored in the memory of another computer prior to use in the system of the present invention and transmitted over a LAN or a WAN, such as the Internet, when required by the user of the present invention. One skilled in the art should appreciate that the processes controlling the present invention are capable of being distributed in the form of computer readable media in a variety of forms.

Any suitable programming language can be used to implement the routines of the present invention including C, C++, Java, assembly language, and the like. Different programming techniques can be employed such as procedural or object oriented. The routines can execute on a single processing device or multiple processors. Although the steps, operations or computations may be presented in a specific order, this order may be changed in different embodiments. In some embodiments, multiple steps shown as sequential in this specification can be performed at the same time. The sequence of operations described herein can be interrupted, suspended, or otherwise controlled by another process, such as an operating system, kernel, and the like. The routines can operate in an operating system environment or as stand-alone routines occupying all, or a substantial part, of the system processing.

In the description herein, numerous specific details are provided, such as examples of components and/or methods, to provide a thorough understanding of embodiments of the present invention. One skilled in the relevant art will recognize, however, that an embodiment of the invention can be practiced without one or more of the specific details, or with other apparatus, systems, assemblies, methods, components, materials, parts, and/or the like. In other instances, well-known structures, materials, or operations are not specifically shown or described in detail to avoid obscuring aspects of embodiments of the present invention.

A “computer-readable medium” for purposes of embodiments of the present invention may be any medium that can contain, store, communicate, transmit, or transport the program for use by or in connection with the instruction execution system, apparatus, system or device. The computer readable medium can be, by way of example only but not by limitation, an electronic, magnetic, optical, electromagnetic, infrared, or semiconductor system, apparatus, system, device, propagation medium, or computer memory.

A “processor” or “process” includes any human, hardware and/or software system, mechanism or component that processes data, signals or other information. A processor can include a system with a general-purpose central processing unit, multiple processing units, dedicated circuitry for achieving functionality, or other systems. Processing need not be limited to a geographic location, or have temporal limitations. For example, a processor can perform its functions in “real time,” “offline,” in a “batch mode,” and the like. Portions of processing can be performed at different times and at different locations, by different (or the same) processing systems.

Reference throughout this specification to “one embodiment”, “an embodiment”, or “a specific embodiment” means that a particular feature, structure, or characteristic described in connection with the embodiment is included in at least one embodiment of the present invention and not necessarily in all embodiments. Thus, respective appearances of the phrases “in one embodiment”, “in an embodiment”, or “in a specific embodiment” in various places throughout this specification are not necessarily referring to the same embodiment. Furthermore, the particular features, structures, or characteristics of any specific embodiment of the present invention may be combined in any suitable manner with one or more other embodiments. It is to be understood that other variations and modifications of the embodiments of the present invention described and illustrated herein are possible in light of the teachings herein and are to be considered as part of the spirit and scope of the present invention.

Embodiments of the invention may be implemented by using a programmed general purpose digital computer, by using application specific integrated circuits, programmable logic devices, field programmable gate arrays, optical, chemical, biological, quantum or nanoengineered systems, components and mechanisms may be used. In general, the functions of the present invention can be achieved by any means as is known in the art. Distributed, or networked systems, components and circuits can be used. Communication, or transfer, of data may be wired, wireless, or by any other means.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope of the present invention to implement a program or code that can be stored in a machine-readable medium to permit a computer to perform any of the methods described above.

Additionally, any signal arrows in the drawings/Figures should be considered only as exemplary, and not limiting, unless otherwise specifically noted. Furthermore, the term “or” as used herein is generally intended to mean “and/or” unless otherwise indicated. Combinations of components or steps will also be considered as being noted, where terminology is foreseen as rendering the ability to separate or combine is unclear.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The foregoing description of illustrated embodiments of the present invention, including what is described in the Abstract, is not intended to be exhaustive or to limit the invention to the precise forms disclosed herein. While specific embodiments of, and examples for, the invention are described herein for illustrative purposes only, various equivalent modifications are possible within the spirit and scope of the present invention, as those skilled in the relevant art will recognize and appreciate. As indicated, these modifications may be made to the present invention in light of the foregoing description of illustrated embodiments of the present invention and are to be included within the spirit and scope of the present invention.

Thus, while the present invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the present invention. It is intended that the invention not be limited to the particular terms used in following claims and/or to the particular embodiment disclosed as the best mode contemplated for carrying out this invention, but that the invention will include any and all embodiments and equivalents falling within the scope of the appended claims. Thus, the scope of the invention is to be determined solely by the appended claims.

What is claimed as new and desired to be protected by Letters Patent of the United States is:

1. A computer-implemented method for providing a real-time web-based debate-forum where people participate in debates and develop ideas and solutions to a debate topic in a controlled and managed environment managed by a computing system, the method comprising: (a) hosting a service-manager supporting a website-interface for the web-based debate-forum, wherein a plurality of users each open an account, access said account, create a profile, post an entry which is displayed on said website-interface, and view on said website-interface one or more entries posted by said plurality of users, associate one or more entries to other entries posted on the web-based debate-forum; (b) starting a plurality of concurrent debate sessions on a plurality of debate-topics which includes for each debate session: opening a debate on the debate-forum, creating a debate profile, posting a description of said debate-topic, and posting one or more entries associated with said debate-topic; (c) registering in the debate-forum one or more other users as members of a group of debate-participants; (d) posting by said debate-participants entries containing feedback, ideas, answers, and comments to said debate-topic and to entries posted by said group of debate-participants; and (e) sequentially posting said entries on said website-interface to develop a stream of entries in at least soft real-time with said real-time sequential posting a priority for the real-time web-based debate-forum.

2. The method of claim 1 wherein said starting step (b) includes: (b1) polling automatically using the computer system, a plurality of data sources for a plurality of candidate debate topics; and (b2) selecting and ranking said plurality of candidate debate topics using the computer system and a predetermined metric to identify said plurality of debate-topics.

3. The method of claim 2 wherein said plurality of data sources includes a plurality of current and contemporary sources including real-time news and social media sources.

4. The method of claim 1 further comprising: (f) identifying and measuring, using the computer system, an interest level metric of each of debate-session.

5. The method of 4 further comprising: (g) identifying, using the computing system, a subset of said plurality of debate-sessions for which said interest level metric exceeds a predetermined threshold; and (h) dynamically generating, using the computer system, a view on said web-interface including said subset of debate-sessions and providing a navigable machine-readable link to each debate-session of said subset of debate-sessions.

6. The method of claim 5 wherein said view on said web-interface includes dynamic generation on a home webpage of said web-interface with said subset of debate-sessions scrolling in realtime without a browser refresh between consecutive updates to said subset of debate-sessions.

7. The method of claim 2 wherein further comprising: (f) identifying and measuring, using the computer system, an interest level metric of each of debate-session.

8. The method of 7 further comprising: (g) identifying, using the computing system, a subset of said plurality of debate-sessions for which said interest level metric exceeds a predetermined threshold; and (h) dynamically generating, using the computer system, a view on said web-interface including said subset of debate-sessions and providing a navigable machine-readable link to each debate-session of said subset of debate-sessions.

9. The method of claim 8 wherein said predetermined metric includes a filter defining one or more topics in said subset of debate-sessions.

10. The method of claim 1 further comprising: (f) moderating said stream of entries in real-time using said computer system to automatically enforce predetermined posting guidelines.

11. The method of claim 1 further comprising: (f) integrating one or more debates from the real-time web-based debate-forum into a commercial broadcast program of television or radio.

12. The method of claim 1 further comprising: (f) participating in said debate-forum on said debate-topic using a first channel of said web-interface by a plurality of said debate-participants; (g) flagging a particular member of said group of debate-participants with a debate-me-now flag and an associated proposed debate-topic; and (h) participating in an additional debate with said particular member on said proposed debate-topic using a second channel of said web-interface while participating in said debate-forum using said first channel.

13. The method of claim 1 further comprising: (f) associating, using said computer system, a plurality of debate avatars with a member of said debate-participants, with individual debate avatars associated with pre-identified activities on said web-interface; (g) presenting, using said computer system, a first one of said debate avatars on said web-interface in association with said member performing a first one of said pre-identified activities associated with said first one debate avatar; and thereafter (h) changing dynamically and automatically, using said computer system, said first one debate avatar to a second one of said debate avatars on said web-interface in association with said member performing a second one of said pre-identified activities associated with said second one debate avatar.

14. The method of claim 1 further comprising: (f)integrating said debate-forum with a plurality of interconnected educational institutions providing a broad geographic teaching environment and wherein said debate-forum includes a group of students from each of said plurality of interconnected educational institutions as debate-participants.

15. The method of claim 15 wherein said debate-forum includes a lecture presented by a lecturer.

16. The method of claim 1 wherein said group of debate-participants are selected as a focus group and wherein said debate-topic represents a market research topic for demographic data development.

17. The method of claim 1 further comprising: (f) integrating a debate-session from the web-based debate forum producing an integrated debate-session using a second service-manager supporting a second website-interface on a separate computing platform.

18. The method of claim 17 wherein said second website-interface includes a blog or other social media forum in addition to said integrated debate-session.

19. The method of claim 1 further comprising: (f) receiving one or more postings of a particular one debate using an alternative communications system, said alternative communications including video, audio, and/or text messaging.

20. The method of claim 1 further comprising: (f) associating, using said computer system, a plurality of issue avatars with a member of said debate-participants, with individual issue avatars visually presenting a pre-identified position for each of a set of debate topics in association with an identification of said member; and (g) presenting, using said computer system, a first one of said issue avatars on said web-interface responsive to said member selecting said pre-identified position for a first debate-topic on a location of said web-interface that includes an identification of said member.

21. The method of claim 20 wherein said set of debate-topics include one or more ballot initiatives and wherein said pre-identified position includes an identification of a voting preference for a ballot initiative of said set of debate-topics.

22. The method of claim 20 wherein said plurality of issue avatars are provided by said system and shared by said group of debate-participants associated with said set of debate-topics.

23. The method of claim 21 further comprising: (g) identifying, using said computer system and responsive to said pre-identified position and associated issue avatar, a particular member of said group of debate-participants associated with a particular pre-identified position; and (h) engaging said particular member to a debate using said web-interface.

24. A computer readable medium storing thereon one or more instruction for providing a real-time web-based debate-forum where people participate in debates and develop ideas and solutions to a debate topic in a controlled and managed environment managed by a computing system, the method of claim 1.

25. A host system for providing a real-time web-based debate-forum where people participate in debates and develop ideas and solutions to a debate topic in a controlled and managed environment managed by a computing system, the system comprising: a database system having a processor system, volatile memory, and non-volatile memory; the non-volatile memory including at least one machine readable medium carrying one or more sequences of instructions for which when implemented causes the processor system to implement the method of claim 1.
